(19) United States
(12) Patent Application Publication
(10) Pub. No.: US 2003/0013605 A1
(43) Pub. Date: Jan. 16, 2003

(54) Catalysis of the hydrogen sorption kinetics of hydrides by nitrides and carbides

(76) Inventors: Thomas Klassen, Hamburg (DE); Rudiger Bormann, Rosengarten (DE); Wolfgang Oelerich, Geesthacht (DE); Volker Guther, Burgthann (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/200,081

(22) Filed: Jul. 19, 2002

Related U.S. Application Data
(63) Continuation-in-part of application No. PCT/DE01/00187, filed on Jan. 17, 2001.

(30) Foreign Application Priority Data
Jan. 20, 2000 (DE) 100 02 117.4

(51) Int. Cl. B01J 27/22; B01J 27/24

(52) U.S. Cl. 502/177; 502/200; 502/400

(57) ABSTRACT

In a storage structure comprising storage material for storing hydrogen by hydrogenation of, and releasing hydrogen by dehydrogenation from the storage material, the storage material consists of a metal, a metal alloy, an inter-metallic phase or a compound material which forms with hydrogen a metal hydride, the storage structure includes a catalyst in the form of a metal nitride or a metal carbide uniformly distributed throughout the storage material.

This is a continuation-in-part application of international application PCT/DE01/00187 filed Jan. 17, 2001 and claiming the priority of German application 100 02 117.4 filed Jan. 20,2000.

### BACKGROUND OF THE INVENTION

The invention relates to an additive for the catalysis of the hydrogenation and the dehydrogenation of hydrogen storage materials as well as a corresponding method of producing a storage material doped with the catalyst.

The ideal energy source for the transport and the ecological conversion of energy is hydrogen. Since, with the conversion of hydrogen into energy for example by means of fuel cells, exclusively water vapors are generated, altogether a closed energy circuit without any detrimental environmental effects is formed. With this ideal energy carrier, it would be possible to produce electrical energy in certain parts of the world and transport it to others.

In this connection, the problem of effectively and safely storing the hydrogen is encountered. Basically, there are three possible alternatives:

1. The storage of hydrogen gas in pressure containers;

2. The liquefaction of hydrogen and storage in cooled special containers;

3. The storage in solid form as metal hydride.

The storage of hydrogen gas in pressure containers is relatively simple but it requires a relatively large amount of energy for the compression and it has the disadvantage of requiring a relatively large amount of space. Liquid hydrogen requires a substantially smaller volume, however, about a third of the energy content is lost for the liquefaction for which the hydrogen has to be cooled to −253° C. Furthermore, the handling of liquid hydrogen, the respective cryogenics and the tank construction are complicated and expensive. Since the fuel cells are operated at a temperature of about 150° C., the hydrogen must further be heated after its removal from the storage tank.

In addition to stationary applications in larger industrial plants, hydrogen is considered for use particularly for transportation, for example, for use in an emission-free automobile. For such applications, gaseous as well as liquid storage facilities are questionable for safety reasons since, during an accident, the tank could rupture whereby the hydrogen could be released in an uncontrolled manner.

In contrast, a storage of the hydrogen in solid form as metal hydride provides for a high safety potential. It is known that various metals and metal alloys can reversibly bind hydrogen. In this connection, the hydrogen is chemically bound and a corresponding metal hydride is formed. By an addition of energy, that is, by heating the metal or, respectively, the metal alloy, the hydrogen is again released so that the reaction is completely reversible. During an accident, the heat supply would be interrupted and, as a result, the hydrogen release would also be interrupted. In addition, in this way, about 60% more hydrogen per volume can be stored than in a liquefied-gas tank. A substantial disadvantage of this storage method has so far been the slow reaction speed, which required charging times of several hours.

Meanwhile, however, with the manufacture of metal alloys with nano-crystalline microstructures, the reaction kinetics have been substantially accelerated over those of the conventional coarse crystalline materials. In the German patent application No. 197 58 384.6 a corresponding process is described which can be operated with limiting conditions that can be relatively easily controlled and which requires a relatively small amount of energy. Furthermore, the process steps generally needed for the activation of the storage material are eliminated.

In order to further increase the reaction speed of the storage materials manufactured so far in this way or otherwise, various metals were added such as nickel platinum or palladium.

For a wider technical utilization of the hydride storage devices however, the reaction kinetics is still too slow, and furthermore, the metallic catalysts mentioned are too expensive and their use is therefore uneconomical.

An alternative solution is the use of oxide catalysts. However, some of the catalysts react with the storage material and, as a result, cause a reduction of the total capacity.

It is therefore the object of the present invention to provide suitable, inexpensive and long-term stable additives for the storage materials which increase the reaction speed during the hydrogenation and dehydrogenation of hydrogen storage materials and a method which permits the manufacture of hydride storage materials provided with catalysts such that materials made in this way can be used in large amounts as hydrogen storage devices wherein the required high reaction speeds for the storage of the hydrogen and its release are ensured.

### SUMMARY OF THE INVENTION

In a storage structure comprising storage material for storing hydrogen by hydrogenation of, and releasing hydrogen by dehydrogenation from, the storage material, wherein the storage material consists of a metal, a metal alloy, an intermetallic phase or a compound material which forms with hydrogen a metal hydride, the storage structure includes a catalyst in the form of a metal nitride or a metal carbide uniformly distributed throughout the storage material.

In this connection, the fact has been utilized that, in comparison with pure metals, metal nitrides are brittle so that a small particle size and a homogeneous distribution in the material according to the invention are achieved. As a result, the reaction kinetics is substantially increased in comparison with metallic catalysts.

Another advantage is that metal nitrides or metal carbides can generally be provided much less expensively than metals or metal alloys so that such storage materials can be made available relatively inexpensively for industrial applications.

The metal nitride or respectively, the metal carbide is basically a nitride or respectively, a carbide of an elemental metal, for example, the nitride or, respectively, carbide of the metals Mg, Al, Si, Ca, Sc, Ti, V, Cr, Mn, Fe, Co, Ni, Cu, Zn, Y, Zr, Nb, Mo, Sn, La, Ce, Hf, Ta, W. In accordance with an advantageous embodiment of the invention, the metal nitride or metal carbide may also consist of mixtures of the metal nitrides or metal carbides or mixed nitrides and mixed carbides and oxynitrides or oxycarbides of the metals, particularly of the metals listed above. Advantageously, also the metals of the rare earths or, respectively, metal mixtures of the rare earth may form the metal nitrides or respectively, metal carbides.

Also, various metal nitrides or metal carbides of the same metal can be used, for example, TiN, Ti₅N₃, Fe₂N, Fe₄N, Fe₃N₄, Cr₂N, CrN, Cr₃C₂, Cr₇C₃, Mn₄N, Mn₂N, Mn₃N₂, VN, V₂N, VC, V₂C, V₆C₅, V₈C₇, etc.

The storage material may consist of various metals, metal alloys, inter-metallic phases or composite materials or of mixtures thereof and also of the respective hydrides of those storage materials.

In an advantageous embodiment of the invention, the storage material has a nano-crystalline structure wherein advantageously also the catalyst has a nano-crystalline structure. If the storage material and/or the catalyst has a nano-crystalline microstructure the reaction speed of the hydration and, respectively, the dehydration of the storage material is further increased.

The method according to the invention for the manufacture of a storage material is characterized in that the material and/or the catalyst are subjected to a mechanical milling process with the aim to obtain a compound powder of the two components so that an optimized reaction surface and an advantageous defect-free structure in the volume of the storage material as well as a uniform distribution of the catalyst are achieved.

The milling process itself can be selected, depending on the storage material and/or the catalyst to be differently long so as to achieve the desired optimal surface of the storage material and the desired optimal distribution of the catalyst.

It may be advantageous in this connection if the storage material itself is first subjected to the milling process and the catalyst is added after a certain time and the milling process is then continued. The procedure however may be reversed, that is the catalyst is first subjected to the milling process and the storage material is subsequently added. Furthermore, the storage material and the catalyst may each be separately subjected to the milling for a certain time and be mixed thereafter and/or they may be subjected to the milling together.

The different procedures possible for the milling process can be selected depending on the storage material and depending on the catalyst to be added; also the milling durations may be selected to be from a few minutes up to 200 hours.

In order to prevent reactions of the storage material with the surrounding gas during the milling process the milling process is preferably performed in an inert gas environment, preferably an argon environment.

However, it may be advantageous to admit carbon or respectively, nitrogen or a gas mixture, which contains nitrogen, to the mechanically or chemically activated surfaces of the ground storage materials while the storage material is subjected to the milling procedure. In this way, a catalyzing carbide or, respectively, nitride can be formed in situ from elements of the storage material.

Below, the invention will be described in greater detail with reference to various diagrams, which show the hydrogenation and dehydrogenation behavior as well as other important parameters.

### BRIEF DESCRIPTION OF THE DRAEWINGS

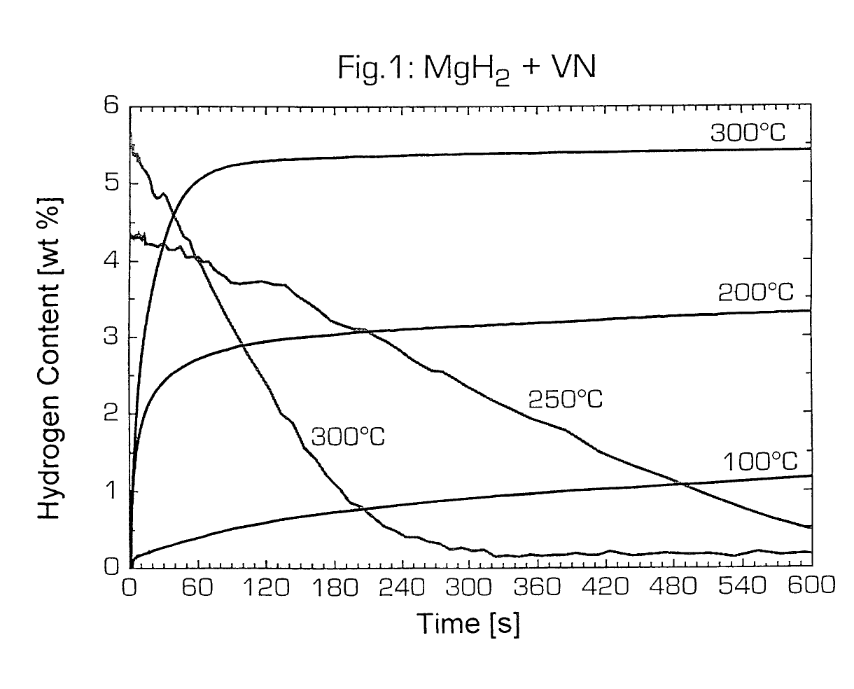

FIG. 1 shows the hydrogen absorption and desorption behavior of the material according to the invention (catalyst vanadium hydride) for the representation of the charging and discharging speed at temperatures between 100° C. and 300° C.

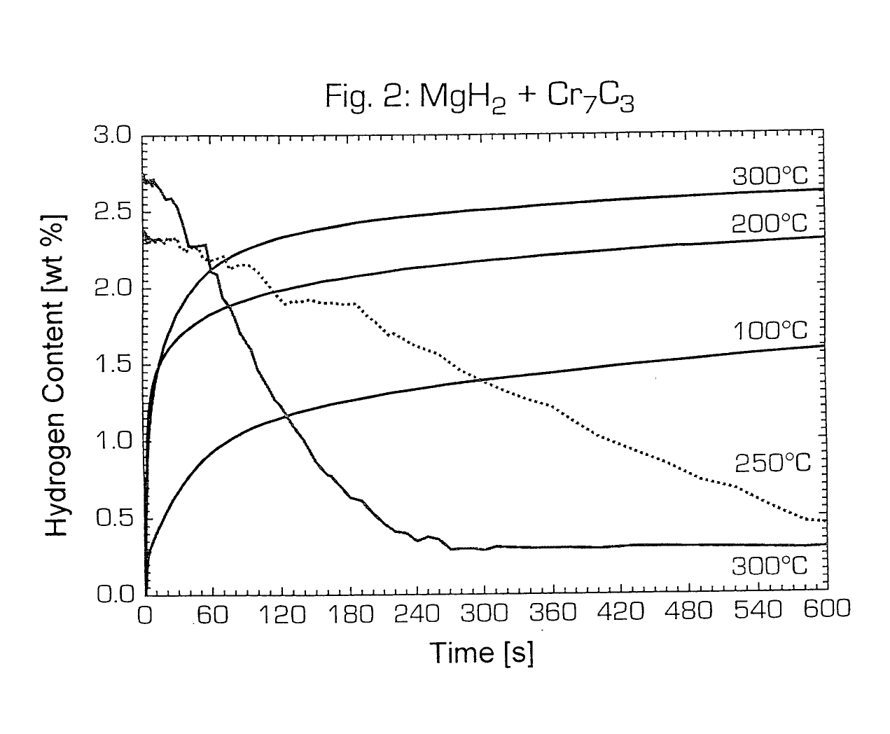

FIG. 2 shows the hydrogen absorption-and description behavior of the material according to the invention (catalyst chromium carbide) for the representation of the charging and discharging speed at temperatures of between 100° C. and 300° C.

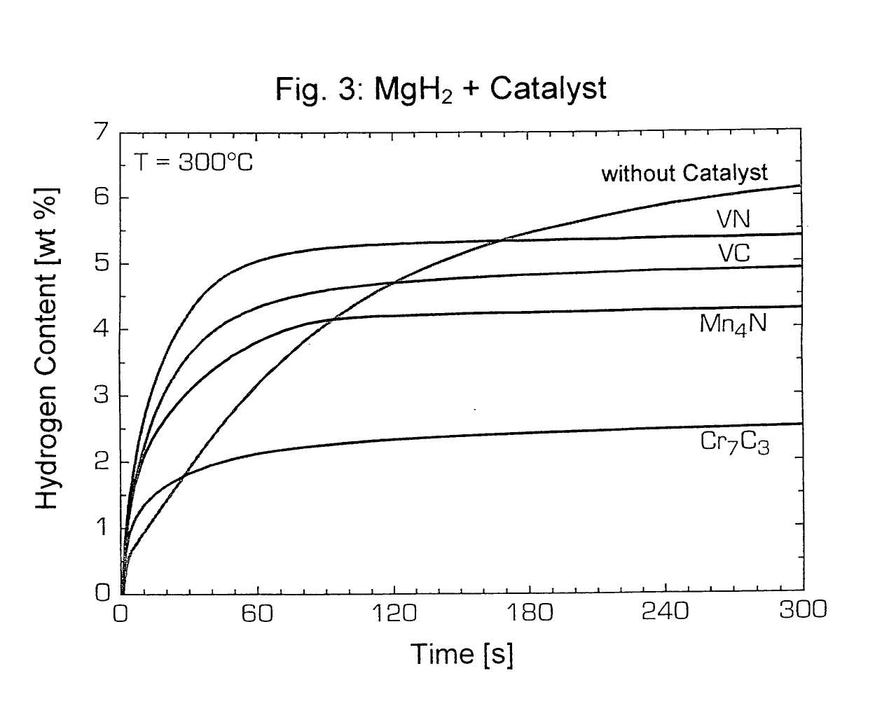

FIG. 3 shows the hydrogen absorption behavior of the material according to the invention for the representation of the charging speed at a temperature of 100° C. in comparison with ground pure MgH₂ without the catalyst according to the invention.

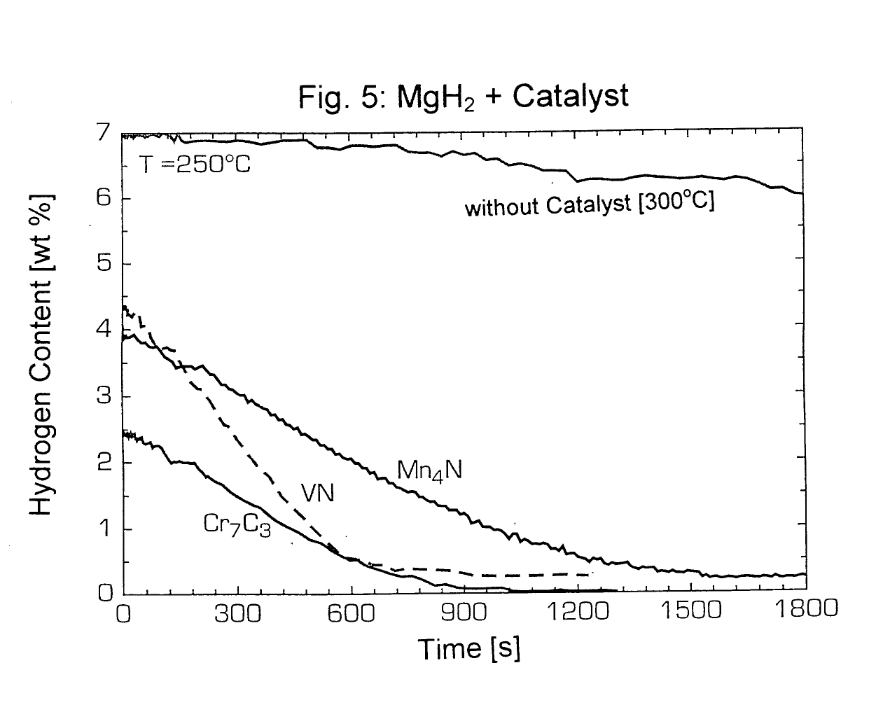

FIG. 5 shows the hydrogen desorption behavior of the material according to the invention for the representation of the discharging speed at a temperature of 250° C. in comparison with ground pure MgH₂ at 300° C. without the catalyst according to the invention and with different oxide catalysts.

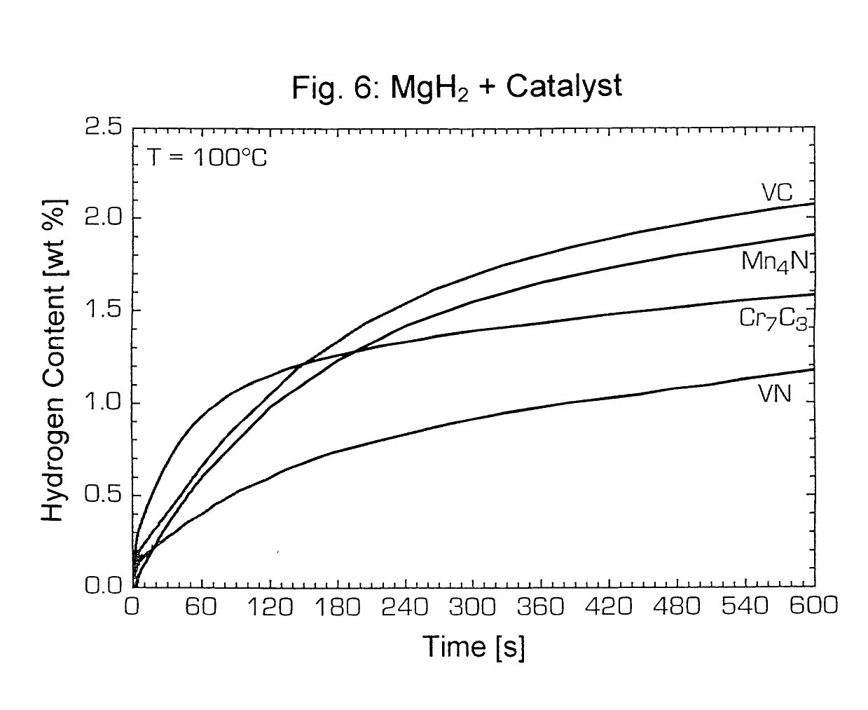

FIG. 6 shows the hydrogen absorption behavior of the material according to the invention for showing the charge speed at a temperature of 100° C. in comparison with ground pure MgH₂ without the catalyst according to the invention.

### DESCRIPTION OF PREFERRED EMBODIMENTS

A method for the manufacture of the storage material according to the invention with the addition of a catalyst will be described on the basis of examples with reference to the figures.

### Example 1:

MgH₂+5 VN

Experimental details: 354 g MgH₂ and 4.6 g VN were introduced at a mole ratio of 19:1 into a 250 ml milling beaker of steel. 400 g steel balls (ball diameter 10 mm, ratio powder: balls =1:10) were added. The powder was subjected to a mechanical high-energy milling process in a planetary ball mill of the type Fritsch Pulverisette 5. The milling process was performed under an argon atmosphere for altogether 200 hours.

Sorption behavior: FIG. 1 shows the absorption and the description of the material at temperatures between 100° C. and 300° C. At a pressure of 150 psi, after 120 s charging time, a hydrogen content of 5.3 or, respectively, 3.0 or 0.6 wt % for temperatures of 300° C. or, respectively, 200° C. or 100° C. was achieved. The desorption with respect to a vacuum is completed at 300° C. or, respectively, 250° C. after about 300 or, respectively, 600 seconds.

### Example 2:

MgH₂+5Cr₂C₂

Experimental details: 22.2 g MgH₂ and 17.8 g Cr₄C₃ at a mole ratio of 19:1 were produced in the way as has been described in example 1.

Sorption behavior: FIG. 1 shows the absorption and desorption of the material at temperatures between 100° C. and 300° C. At a pressure of 150 psi after a charging time of 120 s a hydrogen content of 2.4, 2.0 and 1.2 wt % is reached at temperatures of 300° C., 200° C. and respectively, 100° C. The desorption of the hydrogen with respect to a vacuum is completed at 300° C. or 250° C. after about 300 or, respectively, 600 seconds.

Reaction Kinetics of Magnesium Hydride/Vanadium Nitride and Magnesium Hydride/Chromium Carbide in Comparison with Pure Magnesium Hydride

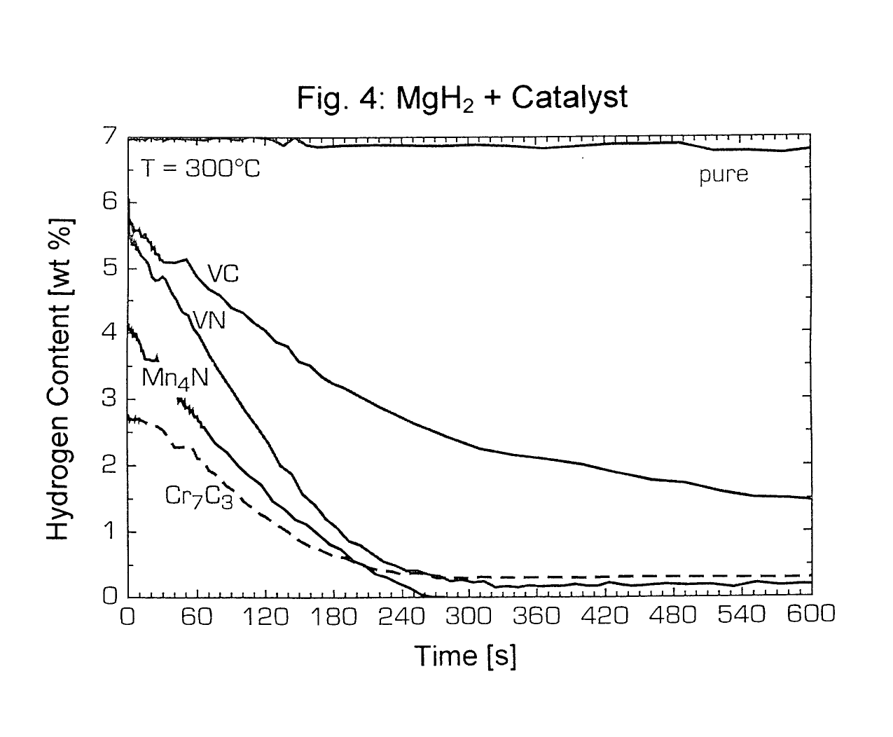

As shown in FIGS. 3-6, there is a clear improvement of the kinetics during the absorption of hydrogen as well as during the desorption thereof in comparison with Mg without the addition of a catalyst. The powder mixtures subjected to the same milling process have different total capacities for hydrogen because of the different densities. FIG. 3 shows the increase of the absorption speed at T=300° C. The speed advantage during desorption at the same temperature is even more apparent (FIG. 4). At T=250° C. and with an addition of VN, the material can be completely dehydrated in about 600 s (FIG. 5), whereas pure MgH₂ exhibits no significant hydrogen release at T =250° C. Furthermore, with the catalysts, hydrogen absorption is possible already at 100° C. (FIG. 6). At this temperature, magnesium hydride, without the addition of a catalyst, does not absorb any hydrogen.

What is claimed is:

1. A storage structure including a storage material for storing hydrogen by hydrogenation and releasing hydrogen by dehydrogenation from said storage material, said storage material consisting of at least one of a metal, a metal alloy, an intermetallic phase and a compound material which forms with hydrogen a metal hydride, said storage structure including a catalyst in the form of at least one of a metal nitride and a metal carbide uniformly distributed throughout the storage material.

2. A storage structure according to claim 1, wherein said catalyst is formed in situ from at least one of said metals, metal alloys intermetallic phases and compound materials activated on the surfaces of said storage material by contact with at least one carbon and nitrogen.

3. A storage structure according to claim 1, wherein said catalyst consists of at least one of nitrides and carbides of one of the following metals or mixed nitrides or mixed carbides or oxynitrides or oxycarbides thereof or that they contain nitrides or carbides or mixed nitrides or mixed carbides thereof: Mg, Al, Si, Ca, Sc, Ti, V, Cr, Mn, Fe, Co, Ni, Cu, Zn, Y, Zr, Nb, Mo, Sn, La, Hf, Ta, W, and rare earths.

4. A storage structure according to claim 1, wherein at least one of said storage and catalyst materials have a nano-crystalline structure.

5. A storage structure according to claim 1, wherein said catalyst materials are uniformly mixed by being subjected together to a milling process.

6. A storage structure according to claim 5, wherein said additives are subjected to a milling process together with at least one of the hydrides of the storage materials.

7. A storage structure according to claim 5, wherein said additives are subjected to the milling process only after the storage materials have been subjected to the milling process for a predetermined time.

8. A storage structure according to claim 5, wherein said catalyst additives are selected so as to facilitate the hydrogenation of the storage materials at temperatures which are reduced in comparison with the non-catalyzed reaction.

9. A storage structure according to claim 5, wherein said catalyst additives are selected so as to facilitate the dehydrogenation of the storage materials at temperatures which are low in comparison with a non-catalyzed reaction.
